(19) United States
(12) Patent Application Publication
(10) Pub. No.: US 2001/0034261 A1
(43) Pub. Date: Oct. 25, 2001

(54) Method for playing games of chance over the internet

(76) Inventors: Gideon Gadot, Ramat Hasharon (IL); Rachel Guetta, Rannana (IL)

Correspondence Address: MERCHANT & GOULD PC, P.O. BOX 2903, MINNEAPOLIS, MN, 55402-0903, US

(21) Appl. No.: 09/808,311

(22) Filed: Mar. 14, 2001

(30) Foreign Application Priority Data
Mar. 16, 2000 (IL) 135119

(51) Int. Cl. A63F 9/24

(52) U.S. Cl. 463/16

(57) ABSTRACT

A method for playing a game of chance in which the interaction with the player is carried out over a data network. At least one virtual game card containing hidden data is displayed to at least one player, via the data network. At least a portion of the hidden data is exposed according to inputs from the player for determining a guessed combination. Each winning player is paid by crediting his financial resource and/or charging the financial resource of each losing player via the data network, according to the level of similarity between the guessed combination and a winning combination.

### FIELD OF THE INVENTION

The present invention relates to the field of games of chance. More particularly, the invention relates to a method for running a game of chance, in which the interaction with the player, payment and/or billing and the determination of winning combinations are carried out over a data network, such as the Internet.

### BACKGROUND OF THE INVENTION

Games of chance are widespread in many countries all over the world, as a means for collecting money from the public for educational, sports and health purposes. These games are usually operated and controlled by governments and/or authorized organizations. The most practical and common way for running such games of chance is selling tickets to players, and filling the tickets with predetermined data, according to which an authorized system determines whether the ticket is a winning ticket. Alternatively, data may be filled into the ticket randomly by an automated machine (e.g., by printing), prior to selling the ticket to the player, and covered with an opaque material. The ticket is then sold to the player, and the player participates in the game of chance by scratching the opaque material according to predetermined instructions (or to the “game rules”), and exposing part of the pre-filled data. A player holding a winning ticket, is paid, after an authentication process of the ticket, according the degree of matching between the filled data and results of a game of chance which is run by an authorized organization, and are associated with the ticket.

Several games of chance, based on scratching and exposing relevant data, are played in many countries. Usually, such games are popular when the player is interested in knowing immediately whether after scratching and exposing the data, his ticket is a winning ticket, or not. These games are relatively attractive, because the player is more involved in the determination of the winning combination. However, conventional methods for playing such games of chance are cumbersome and costly. The game organizers have to print and manufacture tickets, and distribute them to selling points, or alternatively to send them by mail to the player. These operations of course increase the cost of running the game. In addition, payment to a winning player is usually carried out at the selling point, so that the player has to spend time to receive the prize.

Emissions of tickets for playing games of chance suffer from another major drawback, which is the type of distribution. A player who wishes to participate in such game has limited access, only to the tickets that were distributed to a specific selling point. He cannot, for instance, buy tickets that were distributed in another city, unless he goes there physically. Therefore, this limitation reduces the attractivity of the game, since the player faces an unwanted limiting “selection” made for him during the distribution process.

It is therefore desirable to provide an improved method for playing games of chance, in which the player can participate in such games through his home workstation, such as using a conventional Personal Computer (PC), and the player is paid and/or charged by using electronic data communication means.

Oasis™ Gaming (International Gamco Inc., Nebraska, USA) offers Electronic Instant Ticket Vending Machine (ITVM) that displays a scratchable lottery ticket on the video screen of the player, with the same playing characteristics of the paper counterpart. However, this machine functions only as a ticket delivery system, while the game remains a conventional lottery game, in which the player actively determines a guessed winning combination. The scratching operation is used for determining each number in the guessed winning combination, and essentially replaces the filling operation into a paper counterpart ticket, with scratching and exposing a known data. In the Oasis™ game, the winning combination is determined for all the players associated with a specific round of the lottery game, and therefore the Oasis™ game does not provide on-line winning feature. In addition, the Oasis™ game does not offer individual winning criteria and/or individual prize for each player, and in any case, the winning combination is not displayed to the player.

King Solomon's Online Casino (http://www.kingsolomons.com/) offers a variety of online casino games. Among the offered games, such as Roulette, Blackjack, Baccard, Craps and many other famous casino games, there are “scratch” games such as Scratch Card. After downloading and installation of appropriate software from Kings Solomon's web site, the user may gamble in the virtual casino. However, the results in this game are determined by the downloaded software, and not provided to the player via the Internet.

All the methods described above have not yet provided satisfactory solutions to the problem of running a game of chance, played over a data network, which overcome the drawbacks of the prior art.

It is an object of the present invention to provide a method for playing games of chance, played over a data network.

It is another object of the present invention to provide a method for playing games of chance, in which the player exposes a guessed winning combination by virtually scratching hidden data displayed on-screen.

It is still another object of the present invention to provide a method for playing games of chance, in which provides on-line winning and payout features.

It is yet another object of the present invention to provide a method for playing games of chance, which offers individual winning criteria and/or individual prize for each player.

It is a further object of the present invention to provide a method that enables the player who wishes to participate, to have access to all available tickets of the whole emission.

Other objects and advantages of the invention will become apparent as the description proceeds.

### SUMMARY OF THE INVENTION

The present invention is directed to a method for playing a game of chance in which the interaction with the player is carried out over a data network, such as the Internet or an Intranet. At least one virtual game card containing hidden data is displayed to at least one player, via the data network. The hidden data may be predetermined, prior to the participation of the player in the game of chance or generated (e.g., randomly or by scrambling predetermined data) during the game of chance, and filled into the virtual game card according to inputs from the player.

At least a portion of the hidden data is exposed according to inputs from the player and thereby a guessed combination is determined. Each winning player is paid by crediting his financial resource and/or by charging the financial resource of each losing player via the data network, according to the level of similarity between the guessed combination and a winning combination. The winning combination may be remotely transmitted to the display of the player. Preferably, the winning combination is selected among a predetermined number of possible combinations by determining a virtual game card emission. The emission comprises a predetermined number of possible virtual game cards. The winning chances of, or payments to, one or more winning players, are associated with the emission. A request from the first player, to participate in the game of chance is received and the first player is then allowed to access each virtual game card, included in the emission. Upon receiving a new request from the first, or from another player, the first, or the another player is allowed to access only the remaining virtual game cards, included in the emission, which have not been accessed. Preferably, inputs from the player are provided by clicking a mouse-button, or by pressing one or more keys of a keyboard or by pressing areas on a soft touch display.

The financial resource of a player may be his bank account or his credit card. Payments to a winning player may be in the form of granting an object to the winning player. Preferably, the winning combination is displayed to the player during the game of chance.

According to a preferred embodiment of the invention, the game of chance is managed by a computerized center having suitable software. At least one player is connected to the computerized center via a workstation and the data network. Identification data is assigned to each player and authorization for charging and/or crediting a financial resource of the player is acquired. At least one virtual game card having boxes, each of which being associated with predetermined data is generated and displayed to the player via the data network, with the predetermined data being hidden from the player. Inputs from the player are received and at least a portion of the hidden data is exposed accordingly, thereby determining a guessed combination. A winning combination is determined and each winning player is paid by crediting his financial resource and/or charging the financial resource of each losing player via the data network, after authentication of the identification data, and according to a predetermined winning criteria, based on a predetermined full or partial similarity between the guessed combination and the winning combination.

Preferably, the virtual game card comprises:

a) at least a prize table containing one or more boxes, each of which containing hidden data representing a different prize level for a winning player; and

b) graphical means for allowing the player to expose hidden data from one or more boxes.

The virtual game card may further comprise:

c) at least a guessed combination table containing one or more boxes, each of which containing hidden data representing an element of the guessed combination; and

d) graphical means for allowing the player to expose hidden data from one or more boxes in the guessed combination table, for the determination of the guessed combination.

The virtual game card may further comprise:

e) at least a winning combination table containing one or more boxes, each of which containing hidden data representing an element of the winning combination; and

f) graphical means for allowing the player to expose hidden data from one or more boxes in the winning combination table, for the determination of the winning combination.

The virtual game card may further comprise:

a) at least a chance-determining table containing one or more boxes, each of which containing data associated with the level of chance for winning a game, for determining the level of chance taken by the player during the game, the level of chance corresponds to the payment to a winning player; and

b) graphical means for allowing the player to select data from one or more boxes in the chance-determining table, for the determination of the level of chance.

The virtual game card may further comprise:

a) at least a risk-determining table containing one or more boxes, each of which containing hidden data associated with the level of risk taken by the player while playing a game, for determining the level of risk taken by the player during the game, the level of risk limits the winning chances of the player during the game; and

b) graphical means for allowing the player to expose hidden data from one or more boxes in the risk-determining table, for the determination of the level of risk.

Preferably, a limited number of tickets are issued and the first player is allowed to purchase all the issued tickets. Whenever a player wishes to purchase a ticket, all remaining the tickets in the emission are made available for that player.

The invention is also directed to a computerized system for playing a game of chance in which the interaction with the player is carried out over a data network, comprising:

a) a computerized center having suitable software for managing the game of chance;

b) at least one workstation of a player connected to the computerized center via a workstation and the data network;

c) means for assigning identification data to each player;

d) means for acquiring authorization for charging and/or crediting a financial resource of the player;

e) means for generating at least one virtual game card having boxes, each of which being associated with predetermined data;

f) means for displaying the at least one virtual game card to the player via the data network, the predetermined data being hidden from the player;

g) means for receiving inputs from the player and for exposing at least a portion of the hidden data;

h) means for crediting his financial resource and/or charging the financial resource of each losing player via the data network; and

i) means for authentication of the identification data.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a block diagram of a data communication system (based on a data communication network) for playing a game of chance, according to a preferred embodiment of the invention; and

FIG. 2 schematically illustrates a virtual card for playing a game of chance over a data network, according to a preferred embodiment of the invention.

### DETAILED DESCRIPTION OF PREFERRED EMBODIMENTS

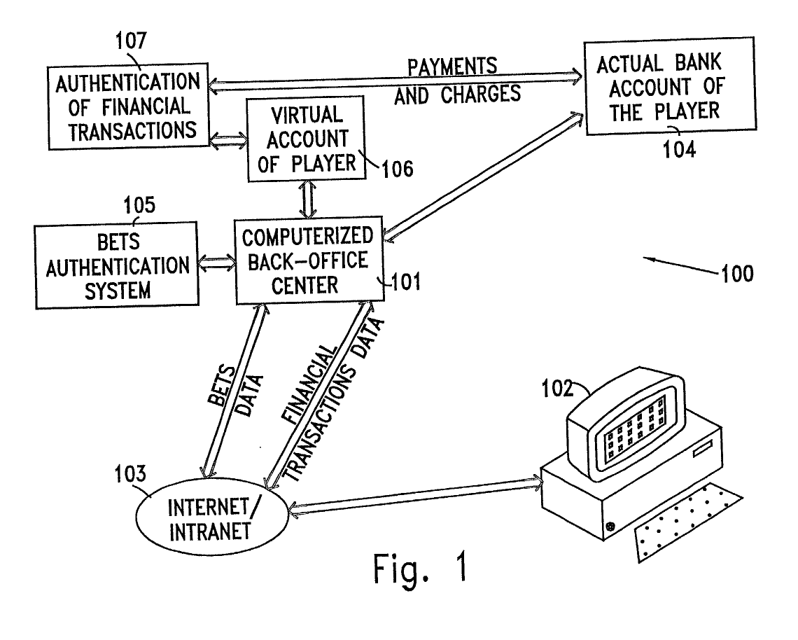

The game of chance disclosed in the present invention is based on computerized interaction between the player, via his workstation, and a computerized center, which is controlled by the organization that runs the game of chance. Interaction between each player and the computerized center is carried out by a data communication network, such as the Internet, or an Intranet. FIG. 1 is a block diagram of a data communication system (based on a data communication network) for playing a game of chance, according to a preferred embodiment of the invention. The system 100 comprises a computerized center 101, linked to the workstation 102 of each player via the data network 103. The computerized center 101 is also linked to the bank account of the player, via the site 104 of the bank, so that the player's account can be charged (up to a predetermined limit) whenever the player loses and/or can be credited whenever the player wins. At the first step, any player who wishes to participate in the game connects his workstation to the site of the computerized center 101. A unique identification data (ID) is assigned to the player, and the player is asked to provide the details of his bank account, or alternatively (only for charging purposes), the details of his credit card. The computerized center 101 operates a built-in or an external bets authentication system 105 for identifying each connected player according to his unique ID, and associating him with his account number. Another bets authentication system 107, is linked to the site 104 of the bank and to a unique virtual account 106 that is assigned by the computerized center 101, to each new player. The authentication system 107 is used to verify financial transactions and to control payment and charges associated with winning (or loosing) results.

At the next step, playing instructions are displayed to each new player and/or to each interested player (e.g., to a player that rarely participates in the game and does not remember the rules of the game), followed by an image of a virtual card are displayed to the player on his screen display. The game is played directly using the interaction of each player the computerized center 101, which provides the player all the required interaction tools for participating in the game, whenever desired, or by downloading suitable software components and/or modules into the workstation 102, which enables the player to virtually “scratch” an opaque virtual layer and expose the underlying data using the workstation's mouse, or by a touch screen. Alternatively, the software may reside on another remote computer and run (by the player) from each connected player's workstation. The player is asked to follow the instructions of the game and to virtually expose hidden data by virtually “scratching” specific areas (normally “boxes”) in the displayed card. Such virtual “scratching” may be carried out, for example by setting the mouse pointer on a selected (and “covered”) box, continuously clicking the left button of the player's mouse, and dragging the pointer over the area of the selected box. Alternatively, selection can be made by the player by pressing a predetermined key on his keyboard. The exposed data in each selected box is transferred on-line to the computerized center 101, which verifies the received data and prompts the player with proper messages, related to errors and/or further instructions, until all the boxes required for completing the current game are selected. When the entire data set is received at the computerized center 101, at the next step, the data is compared with a predefined set of winning criteria (according to the game rules, which are already known to the player), and the player is prompted with a message containing the results of the current game. If the player wins, the message comprises the prize as well, and the account of that specific player is automatically credited accordingly. If the player loses, the message comprises corresponding information, and the account of that specific player is automatically charged with the price of the virtual ticket. Alternatively, the prize may be an object, rather than money, and a corresponding symbol, representing a specific object, can be displayed to the player. The object can be delivered to the player according to the address, which is required from each participating player.

According to a preferred embodiment of the invention, the computerized center 101 comprises a (normally limited) credit system, controlled by corresponding software, which controls the balance of each player in the unique virtual account 106. The credit system enables the player to participate in a game only if he has credit in his virtual account 106. The balance of each player in the credit system may be of an amount which corresponds to more than a single transaction of the player (e.g., when the player deposits a predetermined some of money, in advance), or alternatively, the balance may correspond to an amount associated with a single transaction. At the first step, the player is asked to provide the computerized center 101 a permission to charge his bank account with an initial amount, which covers at least one virtual ticket. At the next step, the player participates in the game, and his virtual account 106 is credited or charged according to the game results. The player can continue with playing more games, until there is no credit left in his virtual account 106. Finally, the player is prompted with a message indicating that there is no more credit in his virtual account, and the player is asked to provide the computerized center 101 additional permission to charge his bank account with the initial amount.

According to another preferred embodiment of the invention, the capability of determining the level of risk and chance is provided to each player by allowing him to select that level from data which is also displayed with the virtual game card. Such data may be arranged, for example, in a table with several boxes, each of which containing the ticket's price that is related to the selected level of chance and to the payment to a player that owns a winning card.

Optional data (e.g., a table) that represents a level of risk may also be included in the displayed virtual card. Each box in that table determines the number of allowed hidden data which can be exposed (by “scratching”) by the player. Winning or loosing in the played game is determined according to the results reflected by the exposed hidden data.

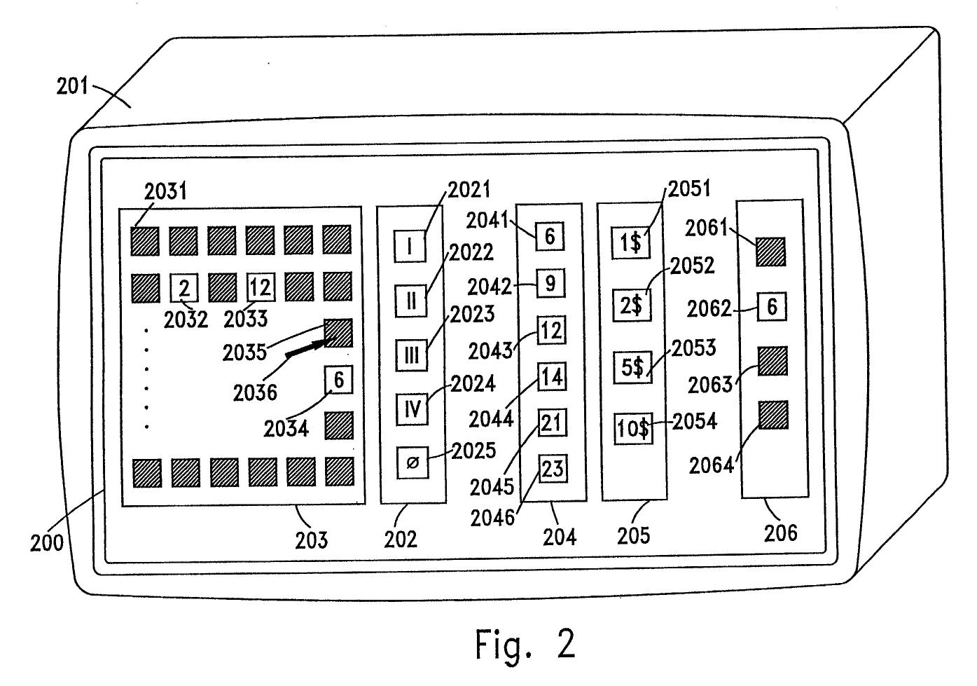

FIG. 2 schematically illustrates a virtual card for playing a game of chance over a data network, according to a preferred embodiment of the invention. The virtual card 200 is displayed on the screen display 201 of the participating player's workstation. The virtual card 200 comprises at least a prize table 202, and may further comprise a guessed combination table 203 and a winning combination table 204. The prize table 202 comprises one or more boxes, 2021 to 2025, each of which containing a predetermined data that represents a prize. The data may be in the form of an amount of money that is paid to a winning player (when the prize is money), or a symbol that represents an object (when the prize is not money) delivered to a winning player. For example, box 2021 comprises the first prize I, which is the highest amount of money, or a predetermined symbol that represents the most valuable object. On the other hand, box 2025 represents no prize symbol. All the boxes in table 202 are displayed to the player with hidden data, and the player is asked to expose the hidden data from a single box, which he selects. Once selection is made, a corresponding signal is sent from the player's workstation (reference numeral 102 in FIG. 1) via the data network 103 to the computerized center 101. The link between the data network 103 and the computerized center 101 is used to exchange data related to bets (i.e., the exposed data), as well as financial transactions data (i.e., billing of ticket purchasing, and payment to, or charging of, a winning player). The software that runs the game disables the selection of other boxes in table 202 by the player (so as to determine the prize for the current game). Data may be assigned to each box randomly, or by scrambling given data.

According to a preferred embodiment of the invention, data is hidden by filling each displayed box with any color, which functions as a virtual “opaque” layer. In practice, no data is actually displayed prior to exposure by the player. When the player wishes to expose the data contained in a box, he selects that box by the workstation's cursor (e.g., the mouse pointer, or an arrow key in the keyboard) and the software displays the data, which is previously assigned to that box. This operation is equivalent to scratching operation of a box containing pre-printed data in a conventional ticket (i.e., “virtual scratching”).

The guessed combination table 203 comprises a plurality of boxes, such as box 2031, each of which containing hidden data (i.e., data that has been already assigned to each box, but not displayed.) The player is asked to virtually “scratch” a single box or a prefixed number of boxes, which determine the winning combination for that specific game of chance. For example, the player selects box 2035, containing hidden data, by pointing with the mouse pointer 2036 on the “opaque” area of that box. The hidden data is exposed by “clicking” on one of the mouse buttons. Boxes 2032 to 2034 (containing the numbers 2, 12 and 6 of the guessed combination, respectively) are selected boxes, the data of which has been exposed by the player. After all the boxes required for a complete guessed combination are exposed, the software disables the exposure of additional boxes. At that point, the guessed combination is determined and saved.

At the next step, the winning combination table 204 is displayed to the player. Table 204 comprises several boxes, 2031 to 2046, each of which containing visible data that determines the winning combination. The software compares the saved (and displayed) guessed combination with the winning combination and determines whether the player wins or not, according to the degree of matching between the guessed combination and the winning combination. For example, the winning combination in table 204 is [6, 9, 12, 14, 21 and 23]. The game of chance may comprise different predetermined winning criteria. For example, the player wins the prize represented by a virtually scratched box in table 202, only if the guessed combination is identical to the winning combination. Alternatively, the player wins if at least four (or any other predetermined number) results match.

According to a preferred embodiment of the invention, the data is randomly generated in the computerized center 101 and/or randomly filled into the boxes of at least one of the tables 202 to 204, of the displayed card 200. This random filling eliminates the need for generating “hidden data”. At the first step, only the framework of card 200 is displayed to the player, with blank boxes. At the next step, the player is asked to select a box in table 202. When the player selects a box, a random number generator is operated on-line by the software (which runs the game of chance) in the computerized center 101, thereby generating a random series of symbols or of numbers, each of which represent a prize. A number or a symbol is (automatically and) randomly selected from the generated series, filled into the selected box and displayed to the player. At this point, the prize is determined randomly by the player. Similarly, when the player selects a box from table 203, a random number generator is operated on-line by the software (which runs the game of chance) in the computerized center 101, thereby generating a random series of numbers, each of which represent a number of the guessed combination. A number is (automatically and) randomly selected from the generated series, filled into the selected box in table 203 and displayed to the player. After repeating this procedure a predetermined number of times, the guessed combination is randomly determined by the player. The same procedure can be repeated for filling the boxes of table 204, for on-line determination of the winning combination. Alternatively, the winning combination may be determined off-line by the computerized center 101 and only displayed to the player.

According to the preferred embodiment of the invention, the displayed card 200 may include a chance-determining table 205 for allowing the player to select the level of chance taken when playing the game. Such level may be represented, for example, by several boxes, 2051 to 2054, each of which displaying a different price for participating in the current game of chance. Prior to playing the game, the player is asked to select a box from table 205. The payment to a winning player is proportional (or related to) to the price displayed by the selected box. In this example, if the player selects box 2054, his credit is charged by a sum of 10$, but if he wins, he is paid 10 times more than a player that selects box 2051 (that corresponds to a 1$ “bet”).

The displayed card 200 may also include a risk-determining table 206 for allowing the player to select the level of risk taken when playing the game.

Such level may be represented, for example, by several boxes, 2061 to 2064, each of which comprising a hidden number that determines the number of boxes that can be exposed by the player in the guessed combination table 203. The player is allowed to expose hidden data only from a single box. This limitation of course affects the chance of the player to win the current game. Prior to playing the game, the player is offered to select a box from table 206. The payment to a winning player becomes higher if the player wishes to risk his winning chances by selecting a box from table 206.

According to the preferred embodiment of the invention, whenever the game is based on emission of finite number of tickets, the players may purchase (via the Internet/Intranet) new tickets of the emission such that the accessibility is equal among all the remaining (un-purchased) tickets of the emission. The first player has access to all tickets in the emission. Whenever another player wishes to play by purchasing tickets from the same emission, he has access to all the remaining tickets in that emission via his workstation.

The above examples and description have of course been provided only for the purpose of illustration, and are not intended to limit the invention in any way. As will be appreciated by the skilled person, the invention can be carried out in a great variety of ways, such as using a soft touch display to receive inputs from the player, employing more than one technique from those described above, all without exceeding the scope of the invention.

1. A method for playing a game of chance in which the interaction with the player is carried out over a data network, comprising:
a) displaying at least one virtual game card containing hidden data to at least one player, via said data network;
b) exposing at least a portion of said hidden data according to inputs from said player, thereby determining a guessed combination; and
c) paying each winning player by crediting his financial resource and/or charging the financial resource of each losing player via said data network, according to the level of similarity between said guessed combination and a winning combination.

2. A method according to claim 1, wherein the winning combination is remotely transmitted to the display of the player.

3. A method according to claim 1, wherein the winning combination is selected among a predetermined number of possible combinations by performing the following steps:
a) determining a virtual game card emission, said emission comprises a predetermined number of possible virtual game cards;
b) associating the winning chances of, or payments to, one or more winning players, with said emission;
c) receiving a request from the first player, to participate in the game of chance;
d) allowing said first player to access each virtual game card, included in said emission; and
e) upon receiving a new request from said first, or from another player, allowing said first, or said another player, to access only the remaining virtual game cards, included in said emission, which have not been accessed.

4. A method according to claim 1, wherein the data network is the Internet.

5. A method according to claim 1, wherein the data network is an Intranet.

6. A method according to claim 1, wherein the user is connected to the data network via a workstation.

7. A method according to claim 1, wherein the hidden data is predetermined, prior to the participation of the player in the game of chance.

8. A method according to claim 1, wherein the hidden data is generated during the game of chance, and filled into the virtual game card according to inputs from said player.

9. A method according to claim 8, wherein the hidden data is generated randomly.

10. A method according to claim 8, wherein the hidden data is generated by scrambling predetermined data.

11. A method according to claim 1, wherein inputs from the player are provided by clicking a mouse-button.

12. A method according to claim 1, wherein inputs from the player are provided by pressing one or more keys of a keyboard.

13. A method according to claim 1, wherein inputs from the player are provided by pressing areas on a soft touch display.

14. A method according to claim 1, wherein the financial resource is a bank account.

15. A method according to claim 1, wherein the financial resource is a credit card.

16. A method according to claim 1, wherein the payment to a winning player is replaced by granting an object to said winning player.

17. A method according to claim 1, further comprising displaying the winning combination to the player.

18. A method according to claim 1, comprising:
a) providing a computerized center having suitable software for managing said game of chance;
b) providing at least one player connected to said computerized center via a workstation and said data network;
c) assigning identification data to each player;
d) acquiring authorization for charging and/or crediting a financial resource of said player;
e) generating at least one virtual game card having boxes, each of which being associated with predetermined data;
f) displaying said at least one virtual game card to said player via said data network, said predetermined data being hidden from said player;
g) receiving inputs from said player and exposing at least a portion of said hidden data accordingly, thereby determining a guessed combination;
h) determining a winning combination; and
i) paying each winning player by crediting his financial resource and/or charging the financial resource of each losing player via said data network, after authentication of said identification data, and according to a predetermined winning criteria, based on a predetermined full or partial similarity between said guessed combination and said winning combination.

19. A method according to claim 18, wherein the virtual game card comprises:
a) at least a prize table containing one or more boxes, each of which containing hidden data representing a different prize level for a winning player; and
b) graphical means for allowing the player to expose hidden data from one or more boxes.

20. A method according to claim 19, further comprising:
c) at least a guessed combination table containing one or more boxes, each of which containing hidden data representing an element of said guessed combination; and
d) graphical means for allowing the player to expose hidden data from one or more boxes in said guessed combination table, for the determination of said guessed combination.

21. A method according to claim 20, further comprising:
e) at least a winning combination table containing one or more boxes, each of which containing hidden data representing an element of said winning combination; and
f) graphical means for allowing the player to expose hidden data from one or more boxes in said winning combination table, for the determination of said winning combination.

20. A method according to any one of claims 19 to 20, further comprising
a) at least a chance-determining table containing one or more boxes, each of which containing data associated with the level of chance for winning a game, for determining the level of chance taken by the player during said game, said level of chance corresponds to the payment to a winning player; and
b) graphical means for allowing the player to select data from one or more boxes in said chance-determining table, for the determination of said level of chance.

21. A method according to any one of claims 19 to 22, further comprising
a) at least a risk-determining table containing one or more boxes, each of which containing hidden data associated with the level of risk taken by the player while playing a game, for determining the level of risk taken by the player during said game, said level of risk limits the winning chances of said player during said game; and
b) graphical means for allowing the player to expose hidden data from one or more boxes in said risk-determining table, for the determination of said level of risk.

22. A method according to claim 1, comprising:
a) issuing a limited number of tickets;
b) enabling the first player to purchase all said issued tickets; and
c) whenever a player wishes to purchase a ticket, enabling all remaining said tickets in said emission to be available for the said player.

23. A computerized system for playing a game of chance in which the interaction with the player is carried out over a data network, comprising:
a) a computerized center having suitable software for managing said game of chance;
b) at least one workstation of a player connected to said computerized center via a workstation and said data network;
c) means for assigning identification data to each player;
d) means for acquiring authorization for charging and/or crediting a financial resource of said player;
e) means for generating at least one virtual game card having boxes, each of which being associated with predetermined data;
f) means for displaying said at least one virtual game card to said player via said data network, said predetermined data being hidden from said player;
g) means for receiving inputs from said player and for exposing at least a portion of said hidden data;
h) means for crediting his financial resource and/or charging the financial resource of each losing player via said data network; and
i) means for authentication of said identification data.
